(19) United States
(12) Patent Application Publication
(10) Pub. No.: US 2006/0221851 A1
(43) Pub. Date: Oct. 5, 2006

(54) System and method for measuring the roundtrip response time of network protocols utilizing a single agent on a non-origin node

(75) Inventors: Paul Fredric Klein, Newbury Park, CA (US); Dannis Taje Yang, West Hills, CA (US)

Correspondence Address: SANDRA M. PARKER, ESQ.;LAW OFFICE OF SANDRA M. PARKER, 329 La Jolla Avenue, Long Beach, CA, 90803, US

(73) Assignee: International Business Machines Corporation, Armonk, NY (US)

(21) Appl. No.: 11/096,765

(22) Filed: Apr. 1, 2005

(51) Int. Cl. H04L 12/26

(52) U.S. Cl. 370/252

(57) ABSTRACT

A computer-based system and method for measuring the roundtrip response time of an original request on a network, utilizing a single response time monitor located on a non-origin node. The method starts the response time monitor on the non-origin node to detect a start time and end time of each component of the original request's roundtrip response time in order to calculate each component's duration. Later, the response time monitor calculates the roundtrip response time by adding together the duration of all components that have the same network address and port number as the original request.

### BACKGROUND OF THE INVENTION

1. Field of the Invention

This invention relates in general to the field of computer networks, and in particular to a method and system for highly efficient measuring of the roundtrip response time of web-based protocols utilizing a single, non-origin measurement point.

2. Description of Related Art

The Internet is a vast network of heterogeneous computers and subnetworks all communicating together to allow for global exchange of information. The World Wide Web (WWW) is one of the more popular information services on the Internet which uses web browser software to decipher hypertext links to documents and files located on remote computers or content servers to access multimedia information in the form of text, audio, video, graphic, animation, still pictures, etc.

Many hardware and software utilities and applications, such as network performance monitors, have as their core technology a method of measurement that depends on network data as their input. In today's Information Technology (IT) industry, measuring roundtrip response time of application program transactions is a very important task. Traditional IT practice is to measure that portion of a computer's transaction time as it relates to time spent executing in one or more application servers. However, today's IT industry has included in its calculation of response time the time spent in areas other than application servers. Specifically, the time a transaction takes traversing a network from an origin client node to a destination server node is becoming one of the most important and desired measurements. One example of this environment is that of a customer using a web browser on a client node and interacting with a corporate web server node. The network time between these two nodes is one of the most important time components of all. However, the calculation of this time component is missing from nearly every commercial response time measurement available to customers today. Only when this component is added to the overall response time equation one can have the total roundtrip response time of a transaction.

The technique involved in measuring roundtrip response time, as well as the network time between an origin and destination node, requires that measurement software is present on both of these nodes. Software must be present on the origin node to capture the time of the initial request and another software must be present on the destination node to capture the time the initial request arrives. The difference is the time the request spent over the network. The problem with this technique is that it requires software to be installed on the origin node. In the IT industry, the origin node is often a computer operated by either an employee or a customer at the client node. Thus, this computer is typically not in the direct control of the corporate web server node to have measurement software placed upon it. One exemplary corporate web site is a bank site that would want to calculate response time for its customers with personal computers at home, yet the customer at home will not be open to downloading and installing banking time measurement software, named response time monitor, used for this purpose. Clearly, the burden of performance measurement must be on the provider of the web server site and not the customer of that site.

One technique that has been tried by a number of vendors is to use a web-based Java applet piece of the web page and automatically download it to the customer's client node. Because it is automatically downloadable, it takes the burden and responsibility off the customer. Java applets act as very small software agents that can measure response time at a customer's origin node. However, this technique requires web site design changes which are intrusive to the customer from a performance perspective and they tend to break the web application they are intended to monitor. In addition, they require complementary software to be placed on the web server at the other end. One such implementation of this technique can be found in the IBM Tivoli QOS solution as well as in the PathWAI eBA Service Monitor solution.

Another issue of conventional solutions is their scalability. Since software agents in the web-based Java applet technique need to reside at each client's origin node, they also have to be managed. Since the web world network has tens of thousands of potential origin nodes, the management effort is staggering. The network traffic caused just by reporting of all these software agents would flood a network and tie up resources.

Therefore, there is a need for a simple, improved, generic and highly efficient response time monitor of web-based protocols that can measure the roundtrip response time and its components from a single, non-origin measurement point, which is the destination node, and not the customer's origin node.

### SUMMARY OF THE INVENTION

The foregoing and other objects, features, and advantages of the present invention will be apparent from the following detailed description of the preferred embodiments, which makes reference to several drawing figures.

One preferred embodiment of the present invention is a computer-based method for measuring the roundtrip response time of an original request on a network, utilizing a single response time monitor located on a non-origin node. The method starts the response time monitor on the non-origin node to detect a start time and end time of each component of the original request's roundtrip response time in order to calculate each component's duration. Later, the response time monitor calculates the roundtrip response time by adding together the duration of all components that have the same network address and port number as the original request.

Another preferred embodiment of the present invention is a system implementing the above-mentioned method embodiments of the present invention.

Yet another preferred embodiment of the present invention includes a computer usable medium tangibly embodying a program of instructions executable by the computer to perform method steps of the above-mentioned method embodiments of the present invention.

### BRIEF DESCRIPTION OF THE DRAWINGS

Referring now to the drawings in which like reference numbers represent corresponding parts throughout:

FIG. 1 illustrates a hardware and software network environment enabling efficient measuring of the roundtrip response time, according to the preferred embodiments of the present invention; and

FIG. 2 illustrates a top level flowchart of the measuring of the roundtrip response time, according to the preferred embodiments of the present invention.

### DETAILED DESCRIPTION OF THE PREFERRED EMBODIMENTS

In the following description of the preferred embodiments reference is made to the accompanying drawings, which form the part thereof, and in which are shown, by way of illustration, specific embodiments in which the invention may be practiced. It is to be understood that other embodiments may be utilized and structural and functional changes may be made without departing from the scope of the present invention.

The main goal of the present invention is to provide a simple, improved, generic and highly efficient response time monitor of web-based protocols which can measure the roundtrip response time and its components utilizing a single, non-origin measurement point, which is the destination node, and not the customer's origin node.

General aspects of the present invention disclose a system, a method and a computer usable medium embodying a program of instructions executable by a computer to measure the roundtrip response time of a request that starts at an origin computing node (client), travels over a network to an application program on another computing node (server) and returns back to the origin node with a response. Beside measuring the roundtrip response time, the aspects of the present invention keep track of each component of the roundtrip response time and can show how much time is spent in each component.

The aspects of the present invention use a single response time monitor for measuring a roundtrip response time and its components, including the network time between the origin and destination node. Thus, the roundtrip response time is calculated with only one software agent which is residing at the destination node. This allows the roundtrip response time to be calculated for any destination node using only network protocols. Thus, no software measurement agent needs to be present at the origin node and there is no burden on the customer.

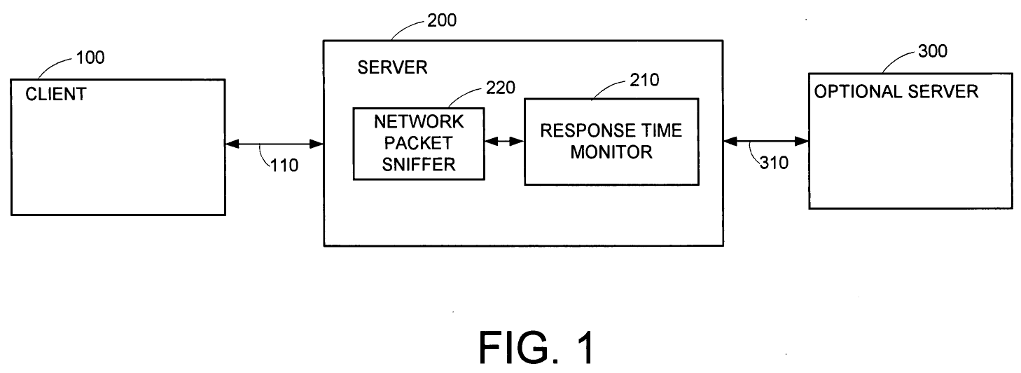

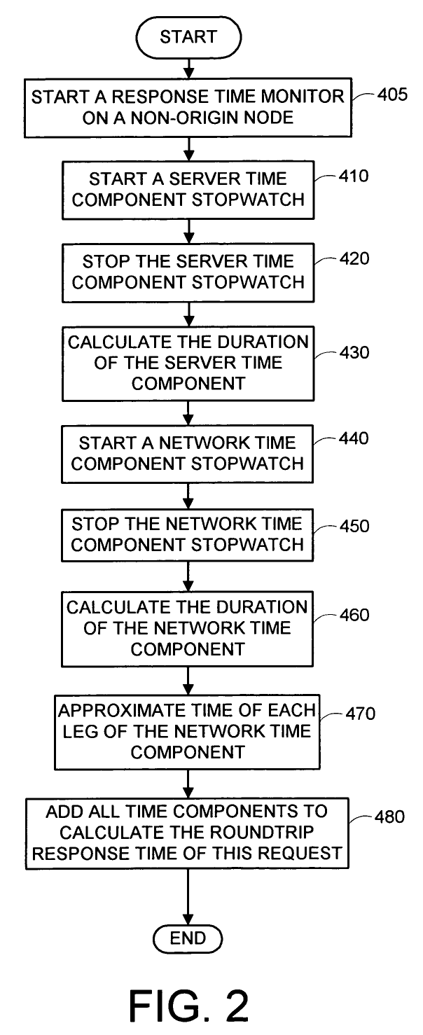

FIG. 1 illustrates a hardware and software network environment enabling efficient calculation of roundtrip response time, according to the preferred embodiments of the present invention. The system uses the algorithm for the roundtrip time calculation shown in the flowchart of FIG. 2. In a block diagram of FIG. 1 a customer at an origin node, named client node 100, interacts with an application on a non-origin node, named server node 200, via a network 110. Network 110 is usually the Internet, using the Transmission Control Protocol/Internet Protocol (TCP/IP), which is the packet switching protocol over the Internet. Client node 100 may be a desktop or laptop computer, personal digital assistant (PDA), onboard vehicle computer, cellular phone, etc, which sends its request, such as a request for a web site, either under the Hypertext Transfer Protocol (HTTP) or under the secured Hypertext Transfer Protocol (HTTPs), to an Internet Service Provider (ISP), not shown. ISP establishes a link to the Internet which then passes the request to a content server, not shown, which forwards the request to a content provider, not shown, typically addressed by Uniform Resource Locator (URL) name.

The response from the content server node 200 is routed back to the client node 100 and is typically compliant with the Hypertext Markup Language (HTML), that is the standard language for creating documents on the WWW. HTML defines the structure and layout of a web document by using a variety of tag commands inserted in the document to specify how a portion or the whole document should be formatted.

A response time monitor 210 of the system aspect of the present invention is connected to a commercial network packet sniffer 220, as illustrated in FIG. 1. This combination operates as an advanced TCP/IP packet sniffing set of software technology which has the ability to measure the response time of an inbound or outbound packet, as seen by a software packet sniffer on a destination node, and can calculate how long a packet took to travel from the origin node and back. For example, if the client node 100 sends a network packet to the server node 200, the response time monitor 210, located on the server 200, can calculate the time from the moment the packet left the client node 100 and arrived at the server node 200. In addition, the response time monitor 210 can measure the time from the moment when a packet leaves the server node 200 for another, optional computing server node 300. Thus, a single measurement software agent located on the server 200, the response time monitor 210, can calculate the time from the client node 100 to server node 200, time on server node 200, time from server node 200 to server 300, and time back to the client node 100, regardless of what protocol is being used by a TCP/IP network.

Algorithm for an exemplary procedure for calculation of the roundtrip time is illustrated by the flowchart of FIG. 2. In the preferred method aspect of the present invention, a user of the client node 100, illustrated in FIG. 1, makes a request which travels on network 110 to server node 200. Response time monitor 210 is started in step 405 of FIG. 2 and it gets information about this request from the commercial network packet sniffer 220 which is always running and watches packets which transverse the network 110. In step 410 of FIG. 2, response time monitor 210 sets a software stopwatch which indicates the starting point of time the request will be spending on server node 200 (start time). Right before the response to the request is placed on the network 110, to be returned to client node 100, the response time monitor 210 is informed of it by the network packet sniffer 220. When it is ascertained that it matches an original request with the same TCP/IP address and port number, the software stopwatch for this request is stopped and end time is recorded in step 420 of FIG. 2. The duration of the time component the request spent on the server node 200 is calculated in step 430 as the time between the start time and end time.

In other aspects of the present invention, this time may also include the time spent on other server nodes, such as server node 300, and a network 310 between the server node 200 and server node 300, since the server node 200 may have called server node 300 for additional information.

However, in the aspects of the present invention the response time monitor 210 is not able to see when the originating transaction actually started at the client node 100. Thus, the present invention uses a technique that approximates the time of origin of a network packet when the actual observation of that packet's time is not feasible. Moreover, the present invention uses the TCP/IP addresses and port numbers to identify the owner of a measured transaction. In this way, response time measurements are made on a transaction-by-transaction basis, for each user, and are not just an average of transaction times of previous users. Other aspects of the present invention use protocol analysis logic that watches for protocol handshakes as well as for session establishment, change direction and session destruction protocols.

For the approximation of a network time component duration, once the response is placed on network 110, another software stopwatch is started by the response time monitor 210 in step 440 of FIG. 2. The response travels over network 110 to client node 100, which returns an acknowledgement to server node 200, detected by the response time monitor 210 which stops the stopwatch in step 450. The duration of this network time component is calculated in step 460. It reflects the roundtrip time the response spent on the network 110, in both directions, between an origin and non-origin node.

Then, in step 470, the aspects of the present invention divide the network time component in two, to produce an approximate time spent on each leg of network time, inbound and outbound of the non-origin node 200. This approximation can be made since the inbound traffic size of the original request or acknowledgement is usually much smaller than the outbound traffic size of the response. Thus, instead of getting the actual measurement of the original inbound request time, which is impossible to know when the response time monitor 210 is located in the server node 200, the present invention approximates the network time of the original inbound request time with the acknowledgement time, which is typically small and of similar size. This approximation of the present invention has proven to average out correctly when performed over large number of measurements. Then, in step 480, the response time monitor 210 adds all time components to calculate the roundtrip response time for this request.

For performance reasons, network components, such as routers, break up each request and response to make them easier to deal with. Thus, each request large in size will be broken up into N packets sent over the network. The commercial packet sniffer 220 sees each of these network packets and the response time monitor 210 keeps track of each packet and calculates its components' time, according to the flowchart of FIG. 2. For example, a request of size 10,000 may be broken up into 10 request packets of size 1,000, and the response time monitor 210 will set software stopwatches for each of these 10 request packets and measure their unique request and response component duration time. After an acknowledgement is received, the response time monitor 210 will add them together to calculate the total roundtrip response time of the original request of size 10,000, including all requests and responses. Therefore, the response time monitor 210 of the present invention can measure the response time of any request and response network protocol, and takes into account all the request packets separately, when created during network transfer, before totaling their components' times to obtain the roundtrip response time.

Moreover, the uniqueness of this aspect of the present invention is its ability to include the request and response time spent on server 300 and network 310, using the same technique as utilized between the client 100 and server 200. The total roundtrip time from the original request on client 100 to server 200, then to server 300 and back, until the response is received by the client 100 equals:
Roundtrip Time=network 110 time+server node 200 time+server node 300 time+network 310 time

In some aspects of the present invention, when server 300 is involved, the response time monitor 210 can learn the roundtrip time spent on server 300 and network 310. This may be accomplished by placing another response time monitor on server 300. Then, the component of the roundtrip response time spent solely on server 200 can be calculated by subtracting the time spent in server 300 and network 310.

With the present invention a corporation can place a single software measurement agent at their server node and measure the roundtrip response time of the thousands of customers that access their server node without any intrusion or software deployment on any of the customers' computers.

The present invention can be realized in hardware, firmware or software, any combination of hardware, firmware and software, or in any other process capable of providing the disclosed functionality. Implementation of the method and system of the present invention can be realized in a centralized fashion in one server computer system, or in a distributed fashion where different elements are spread across several interconnected computer systems. Any type of computer system or apparatus adapted for carrying out the methods described herein is suited to perform the functions described herein. FIG. 1 illustrates general purpose computer systems with a group of computer programs which, when being loaded and executed, control the computer system in such a way that it carries out the method aspects of the present invention. The computer programs can be embedded in a computer usable medium which comprises all the features enabling the implementation of the methods described herein and which are able to carry out these methods when loaded in a computer system. In the exemplary environment of FIG. 1, a computer system of the server node 200 is comprised of one or more processors, not shown, which may be connected to memory, not shown, and one or more electronic storage devices, not shown, such as disk drives.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for measuring the roundtrip response time of an original request on a network, utilizing a single response time monitor located on a non-origin node, comprising:
(a) starting the response time monitor on the non-origin node; and
(b) using the response time monitor to detect a start time and end time of each component of the original request's roundtrip response time in order to calculate each said component's duration.

2. The method according to claim 1, further comprising a step of having the response time monitor calculate the roundtrip response time by adding together the duration of all said components, wherein the components having the same network address and port number as the original request.

3. The method according to claim 1, wherein the network is Internet, the network protocol is a Transmission Control Protocol/Internet Protocol (TCP/IP), and the request is compliant with the Hypertext Markup Language (HTML).

4. The method according to claim 1, wherein the response time monitor calculates the duration of each packet component of the original request or its response packet component separately, when the original request or response is broken into packets during the network transfer.

5. The method according to claim 1, wherein the components of the roundtrip response time comprise a network time component, calculated as a time between an origin and the non-origin node, and a non-origin node time component.

6. The method according to claim 5, wherein the network time component:
includes an inbound network time of the original request from the origin node to the non-origin node and an outbound network time returning a response back to the origin node, and
is calculated as a duration of the outbound network time component returning the response from the non-origin node back to the origin node and a duration of an acknowledgement from the origin node being received by the non-origin node.

7. The method according to claim 6, wherein the non-origin node comprises a first non-origin node using data from a second non-origin node, and wherein a duration of the roundtrip time component spent solely on the first non-origin node is calculated by subtracting from the non-origin node time a duration spent in the second non-origin node and a network time between the first and second non-origin nodes.

8. A system for measuring the roundtrip response time of an original request on a network, utilizing a single response time monitor located on a non-origin node, comprising the means for:
(a) starting the response time monitor on the non-origin node; and
(b) using the response time monitor to detect a start time and end time of each component of the original request's roundtrip response time in order to calculate each said component's duration.

9. The system according to claim 8, further comprising a means for having the response time monitor calculate the roundtrip response time by adding together the duration of all said components, wherein the components having the same network address and port number as the original request.

10. The system according to claim 8, wherein the network is Internet, the network protocol is a Transmission Control Protocol/Internet Protocol (TCP/IP), and the request is compliant with the Hypertext Markup Language (HTML).

11. The system according to claim 8, wherein the response time monitor calculates the duration of each packet component of the original request or its response packet component separately, when the original request or response is broken into packets during the network transfer.

12. The system according to claim 8, wherein the components of the roundtrip response time comprise a network time component, calculated as a time between an origin and the non-origin node, and a non-origin node time component.

13. The system according to claim 12, wherein the network time component:
includes an inbound network time of the original request from the origin node to the non-origin node and an outbound network time returning a response back to the origin node, and
is calculated as a duration of the outbound network time component returning the response from the non-origin node back to the origin node and a duration of an acknowledgement from the origin node being received by the non-origin node.

14. The system according to claim 13, wherein the non-origin node comprises a first non-origin node using data from a second non-origin node, and wherein a duration of the roundtrip time component spent solely on the first non-origin node is calculated by subtracting from the non-origin node time a duration spent in the second non-origin node and a network time between the first and second non-origin nodes.

15. A computer usable medium, tangibly embodying a program of instructions executable by the computer to perform a method for measuring the roundtrip response time of an original request on a network, utilizing a single response time monitor located on a non-origin node, comprising:
(a) starting the response time monitor on the non-origin node; and
(b) using the response time monitor to detect a start time and end time of each component of the original request's roundtrip response time in order to calculate each said component's duration.

16. The method according to claim 15, further comprising a step of having the response time monitor calculate the roundtrip response time by adding together the duration of all said components, wherein the components having the same network address and port number as the original request.

17. The method according to claim 15, wherein the network is Internet, the network protocol is a Transmission Control Protocol/Internet Protocol (TCP/IP), and the request is compliant with the Hypertext Markup Language (HTML).

18. The method according to claim 15, wherein the response time monitor calculates the duration of each packet component of the original request or its response packet component separately, when the original request or response is broken into packets during the network transfer.

19. The method according to claim 15, wherein the components of the roundtrip response time comprise a network time component, calculated as a time between an origin and the non-origin node, and a non-origin node time component.

20. The method according to claim 19, wherein the network time component:
includes an inbound network time of the original request from the origin node to the non-origin node and an outbound network time returning a response back to the origin node, and
is calculated as a duration of the outbound network time component returning the response from the non-origin node back to the origin node and a duration of an acknowledgement from the origin node being received by the non-origin node.

21. The method according to claim 20, wherein the non-origin node comprises a first non-origin node using data from a second non-origin node, and wherein a duration of the roundtrip time component spent solely on the first non-origin node is calculated by subtracting from the non-origin node time a duration spent in the second non-origin node and a network time between the first and second non-origin nodes.
